(19) United States
(12) Patent Application Publication
(10) Pub. No.: US 2011/0085088 A1
(43) Pub. Date: Apr. 14, 2011

(54) SYSTEM AND METHOD FOR COORDINATION OF ANALOG AND DIGITAL CHANNEL MAPPING

(75) Inventors: Khelan Modi, Fishers, IN (US); Steven L. Cooper, Whitestown, IN (US)

(73) Assignee: SHENZHEN TCL NEW TECHNOLOGY LTD., Shekou, Shenzhen, Guangdong (CN)

(21) Appl. No.: 12/993,425

(22) PCT Filed: Oct. 24, 2008
(86) PCT No.: PCT/US08/81155

§ 371 Date: Nov. 18, 2010

(30) Foreign Application Priority Data
Jun. 13, 2008 (CN) 200810067696.4

(51) Int. Cl. H04N 5/50

(52) U.S. Cl. 348/732; 348/E05.097

(57) ABSTRACT

There is provided a system and method for coordinating analog and digital channel mapping features. More specifically, in one embodiment, there is provided a method, comprising performing an analog channel search to identify available analog channels, storing a list of the available analog channels found during the analog channel search, and performing a digital channel search after performing the analog channel search, wherein the digital channel search excludes the available analog channels in the list from being searched.

### FIELD OF THE INVENTION

The present invention relates generally to a system and method for channel mapping and, more specifically, to avoiding inefficiencies associated with channel map features for digital-ready televisions.

### BACKGROUND OF THE INVENTION

This section is intended to introduce the reader to various aspects of art, which may be related to various aspects of embodiments of the present invention that are described and/or claimed below. This discussion is believed to be helpful in providing the reader with background information to facilitate a better understanding of the various aspects of embodiments of the present invention. Accordingly, it should be understood that these statements are to be read in this light, and not as admissions of prior art.

Digital television, a service offered by many cable distributors, utilizes digital technology to facilitate provision of a larger number of channels to users than would be available with analog channels alone. Using video compression and digital channels, cable distributors may increase the number and diversity of programs available on their existing cable networks without requiring network additions. In view of the number of channels available from both digital and analog sources, it may be desirable or necessary to store a channel map to facilitate navigation through available broadcasts. A channel map may be defined as a list of channels present in a given cable or antenna lineup.

It is often more cost effective to produce a digital-ready television that receives both digital and analog signals by using a non-integrated tuning solution. In other words, it is often desirable to use a digital component for accessing digital channels and a separate analog component for accessing analog channels. This can be the case for a number of reasons. For example, analog components are generally cheaper than digital components and the cost of integrating the two is generally considered a prohibitive development cost. However, while utilizing an analog component to access analog channels and a digital component to access digital channels can be more cost effective, performance can be negatively impacted. For example, when a channel map is being created by performing a channel search to identify available channels, there may be some inefficiency based on underutilized overlap between digital and analog channel maps.

### BRIEF DESCRIPTION OF THE DRAWINGS

Advantages of the invention may become apparent upon reading the following detailed description and upon reference to the drawings in which:

FIG. 1 is a block diagram of an electronic device in accordance with an exemplary embodiment of the present invention; and

FIG. 2 is a process flow diagram representing channel map processing in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

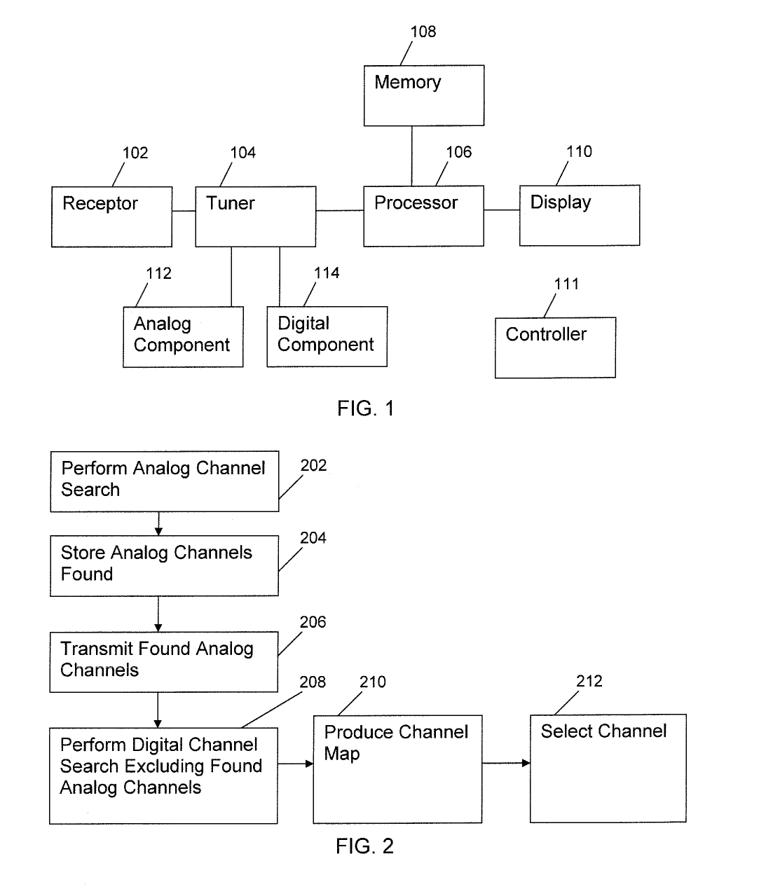

FIG. 1 is a block diagram of an electronic device in accordance with an exemplary embodiment of the present invention. The electronic device (e.g., a television) is generally referred to by the reference number 100. The electronic device 100 comprises a receptor 102 (e.g., a cable inlet or an antenna), a tuner 104, a processor 106, a memory 108, a display 110, and a controller 111 (e.g., remote control). The memory 108 may be adapted to hold machine-readable computer code that causes the processor 106 to perform an exemplary method in accordance with the present invention. The tuner 104 includes an analog component 112 and a digital component 114. The analog component 112 and the digital component 114 are separate (i.e., a non-integrated solution). The tuner 104 is utilized in performance of separate analog and digital channel searches that are combined in accordance with present embodiments to establish a channel map. The processor 106 may receive the channel map data via the tuner and/or other information from a service provider (e.g., a cable provider).

Embodiments of the present invention are directed to reducing the time required to establish a channel map including both analog and digital channels. More specifically, embodiments of the present invention are directed to providing an efficient system that utilizes a non-integrated solution. This is achieved by establishing the type of channel to be mapped first and by sharing data between the separate analog and digital components of the non-integrated solution.

FIG. 2 is a process flow diagram 200 representing channel map processing in accordance with an exemplary embodiment of the present invention. For example, mapping channels (e.g., video signals) and storing them in memory may include searching available channels with the tuner 104 and mapping those channels having a sufficiently clear signal. Specifically, in accordance with present embodiments, a channel search for analog channels is performed by the analog component 112, as illustrated by block 202. A list of channels found during the analog channel search of block 202 are then stored in the memory 108, as illustrated by block 204. This list of found analog channels is transmitted via a command protocol to the digital component 114, as illustrated by block 206. In one embodiment, the list of found analog channels may be transmitted from the analog component 112 to the digital component 114. Once the list of found analog channels is received by the digital module 114, the digital module 114 performs a digital channel search on the channels that were not found in the analog channel search, as illustrated by block 208.

By performing the analog channel search (block 202) prior to the digital channel search (block 208), the overall time required for a channel search in the non-integrated solution is reduced compared to traditional techniques and systems involving non-integrated solutions. Indeed, traditional techniques require a digital channel search on all channels. This can require a significant amount of time. Since the search for a signal on a digital channel requires more time than on an analog channel, embodiments of the present invention, which prevent the digital channel search from spending time on analog channels that have already been found, are more efficient than traditional techniques and systems. For example, present embodiments may be especially efficient in an environment which contains a large number of analog channels, such as a cable provider input.

The channels searched in accordance with present embodiments may be designated based on a mode of operation. For example, channels 2-69 may be searched in a terrestrial mode, and channels 1-135 may be searched in a cable mode.

The analog channel search represented by block 202 may be performed using the analog component 112 of the tuner 104. For analog channels, the tuner 104 is tuned to a nominal frequency to check for the automatic fine tuning (AFT) component and sync to determine if an analog channel is available. For terrestrial mode, tuning to the nominal frequency is sufficient. For cable mode, additional steps are performed such as a determination of whether an incoming signal employs harmonically related carriers (HRC) or incrementally related carriers (IRC).

The digital channel search represented in block 206, which is performed after the analog channel search in block 202, may be performed using the digital component 114 of the tuner 104. The tuner is tuned to a nominal frequency for the channel. For the digital channel search, a modulation scheme is used to determine valid transport packets. In terrestrial mode, an 8 vestigial side band (8 VSB) modulation scheme may be utilized. For cable mode, an 8 VSB, 64 quadrature amplitude modulation (QAM) or 256 QAM modulation scheme may be utilized. Once a modulation scheme is selected, a link checks for valid transport packets. If no valid transport packets are found, it is determined that there is no digital channel available on the designated frequency. This may be performed on all channels that are not already designated as found analog channels.

FIG. 2 further illustrates production of a channel map in block 210 based on a combination of the found analog and found digital channels. Further block 212 represents selection of channels for display by a user. For example, this may include selecting certain channel numbers on a television panel or remote control for display of the associated content on a television screen.

Typically, there are more analog channels than digital channels available from a given provider. Accordingly, present embodiments significantly reduce the number of channels over which a digital channel search is performed. In other words, because many channels will already be designated as found analog channels, fewer channels will be searched in the digital channel search. Thus, channel searching will be more efficient. However, as more and more digital channels are made available, this logic can be reversed in accordance with present embodiments such that digital channels are searched first and then analog channels are searched only on the channels that are not found during the digital channel search. For example, a user may select which type of channel search to perform first by designating the analog module 112 or the digital module 114 as a primary module. For example, this may be achieved via a switch or button-activated command disposed on a controller of the device 100 (e.g., the controller 111).

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method, comprising:
performing an analog channel search to identify available analog channels;
storing a list of the available analog channels found during the analog channel search; and
performing a digital channel search after performing the analog channel search, wherein the digital channel search excludes the available analog channels in the list from being searched.

2. The method of claim 1, comprising transmitting the list of available analog channels from an analog component to a digital component.

3. The method of claim 1, wherein performing the analog channel search comprises searching terrestrial mode channels for the available analog channels.

4. The method of claim 3, wherein searching the terrestrial mode channels comprises searching channels 2 through 69.

5. The method of claim 1, wherein performing the digital channel search comprises searching cable mode channels.

6. The method of claim 5, wherein searching the cable mode channels comprises searching all of channels 1 through 135, except for the available analog channels in the list.

7. The method of claim 1, wherein performing the digital channel search comprises selecting a modulation scheme from a plurality of modulation schemes and checking for valid transport packets with the modulation scheme.

8. The method of claim 7, wherein the modulation scheme comprises an 8 vestigial side band, 64 quadrature amplitude modulation or 256 quadrature amplitude modulation scheme.

9. The method of claim 1, wherein performing the digital channel search comprises determining that no digital signal is available on a particular channel when no valid transport packets with any of a plurality of modulation schemes are found.

10. The method of claim 1, comprising modifying a digital channel catalog by eliminating the available analog channels in the list that have redundancies in the digital channel catalog and wherein performing the digital channel search includes searching the digital channel catalog after it has been modified.

11. A system, comprising:
an analog module configured to perform an analog channel search to identify available analog channels;
a memory configured to store a list of the available analog channels found during the analog channel search; and
a digital module configured to perform a digital channel search after the analog channel search, wherein the digital channel search excludes the available analog channels in the list from being searched.

12. The system of claim 11, wherein the analog module is configured to search terrestrial mode channels for the available analog channels.

13. The system of claim 12, wherein the terrestrial mode channels comprise channels 2 through 69.

14. The system of claim 11, wherein the digital module is configured to search cable mode channels.

15. The system of claim 14, wherein the cable mode channels comprise all of channels 1 through 135 except for the available analog channels in the list.

16. The system of claim 1, the digital module is configured to select a modulation scheme from a plurality of modulation schemes and checking for valid transport packets with the modulation scheme.

17. A system, comprising:
an analog module configured to perform an analog channel search to identify available analog channels;
a digital module configured to perform a digital channel search to identify available digital channels;
a memory configured to store a list of the available analog or digital channels found during the analog or digital channel search; and
a primary channel search designation module configured to designate the analog module or the digital module as a primary module such that when the analog module is designated as the primary module, the analog channel search is performed before the digital channel search, and such that when the digital module is designated as the primary module, the digital channel search is performed before the analog channel search.

18. The system of claim 17, wherein the digital channel search excludes the available analog channels in the list from being searched when the analog module is designated as the primary module.

19. The system of claim 17, wherein the analog channel search excludes the available digital channels in the list from being searched when the digital module is designated as the primary module.

20. The system of claim 17, wherein the primary channel search designation module comprises a switch or button on a television controller.
